(19) United States
(12) Patent Application Publication
(10) Pub. No.: US 2014/0109003 A1
(43) Pub. Date: Apr. 17, 2014

(54) SYSTEM AND METHOD FOR SELECTIVELY MUTING COMPUTER APPLICATIONS

(71) Applicant: APPSENSE LIMITED, Warrington (GB)

(72) Inventors: Joseph SAIB, Santa Clara, CA (US); Jonathan WALLACE, Coral Springs, FL (US); Harpreet Singh LABANA, Millwood, NY (US)

(73) Assignee: APPSENSE LIMITED, Warrington (GB)

(21) Appl. No.: 13/649,993

(22) Filed: Oct. 11, 2012

(51) Int. Cl. G06F 3/048

(52) U.S. Cl. 715/808; 715/810; 715/835

(57) ABSTRACT

Embodiments of the invention include a computer, computer program product and computer implemented method for allowing a user to mute selectively a computer application. In some embodiments, the computer comprises a computer display and a tangible non-transitory computer memory, the computer memory having stored thereon a plurality of computer instruction performing a process of creating a menu of computer applications running on the computer and a process of allowing the user to select from the menu of applications a particular application to mute. The instructions and computer program product, in some embodiments, determine whether an application running on the computer is generating a sound signal; add the application to a list of applications that are generating sound signals; and create a menu from the list for viewing by the user on the computer display, the menu including a name of the application and a mute icon.

### FIELD OF THE INVENTION

Embodiments of the invention relate in general to software applications for use on computers and more particularly to a software application for controlling the sound of a plurality of applications running on a computer.

### BACKGROUND OF THE INVENTION

Currently, when a user connects to an application generating sound there are two results. If the user has only one audio output device, and a basic sound card, the latest application opened by the user plays. If the user has multiple output devices (e.g., computer speakers, television speakers, iPod®, etc.), and/or a sound card enabling multiple output channels, all applications will play simultaneously, and the user must go into each application to selectively mute the applications. This can be a time consuming process, especially when the last connected application is a priority application. For example, a user that is listening to music on an iPod®, playing a video game using television audio, and watching a YouTube® video on a computer, might receive an important Skype® call. To answer the call, and mute all other applications, the user would need to go into each application to adjust the volume or mute the application, which could cause the user to miss the Skype® call. Alternatively, the user can answer the call, but the caller would know what the user was listening to and/or watching when the call was received. Moreover, if the user wished to speak with the caller without listening to the applications, the caller would have to hold or wait for the user to mute same.

In other situations, a user may wish to listen to two or more audio streams simultaneously (e.g., to compare sound quality of the audio streams, determine whether tracks have been edited, etc.). In such situations, the user would need to switch between audio applications to selectively mute or adjust the volume for the tracks. This process could cause the user to miss important differences between the tracks.

A need exists for a method and system that solves the issues identified above.

### SUMMARY OF THE INVENTION

One embodiment of the invention is a computer for allowing a user to selectively mute one or more computer applications. In some embodiments, the computer comprises a computer display and a tangible non-transitory computer memory, the computer memory having stored thereon a plurality of computer instruction performing a process of creating a menu of computer applications running on the computer and a process of allowing the user to select from the menu of applications a particular application to mute. The instructions include the steps of determining whether an application running on the computer is generating a sound signal; responsive to determining whether an application is generating a sound signal, adding the application to a list of applications that are generating sound signals; and creating a menu from the list for viewing by the user on the computer display, the menu including at least one of a name of the application and a mute icon.

Another embodiment of the invention is a computer program product comprised of a series of instructions executable on a computer. In some embodiments, the computer program product performs a process of creating a menu of computer applications running on the computer and a process of allowing the user to select from the menu of applications a particular application to mute. Such instructions may include the steps of determining whether an application running on the computer is generating a sound signal; responsive to determining whether an application is generating a sound signal, adding the application to a list of applications that are generating signals; and creating a menu from the list for viewing by the user on the computer display, the menu including at least one of a name of the application and a mute icon.

Another embodiment of the invention is a computer-implemented method comprised of a series of instructions that cause a computer to perform a process of creating a menu of computer applications running on the computer and a process of allowing the user to select from the menu of applications a particular application to mute. In some embodiments, the instructions include the steps of determining whether an application running on the computer is generating a sound signal; responsive to determining whether an application is generating a sound signal, adding the application to a list of applications that are generating sound signals; and creating a menu from the list for viewing by the user on the computer display, the menu including at least one of a name of the application and a mute icon.

### BRIEF DESCRIPTION OF THE FIGURES

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is an electronic block diagram of a user computer implementing the system according to an embodiment of the invention;

FIG. 2 is a software block diagram of a user computer having a program product in memory thereon including several operation modules according to an embodiment of the invention;

FIG. 3 is a software flow diagram for determining the applications that are generating a sound signal according to an embodiment of the invention;

FIG. 4 is a software flow diagram for displaying the applications that are generating a sound signal according to an embodiment of the invention;

FIG. 5 is a software flow diagram for enabling the user to adjust the volume of an application according to an embodiment of the invention; and

FIG. 6 is an exemplary graphical user interface (“GUI”) according to an embodiment of the invention.

### DETAILED DESCRIPTION

To address the need set forth above, according to one aspect, the invention includes a user computer, a computer display, a computer network and audio listening devices.

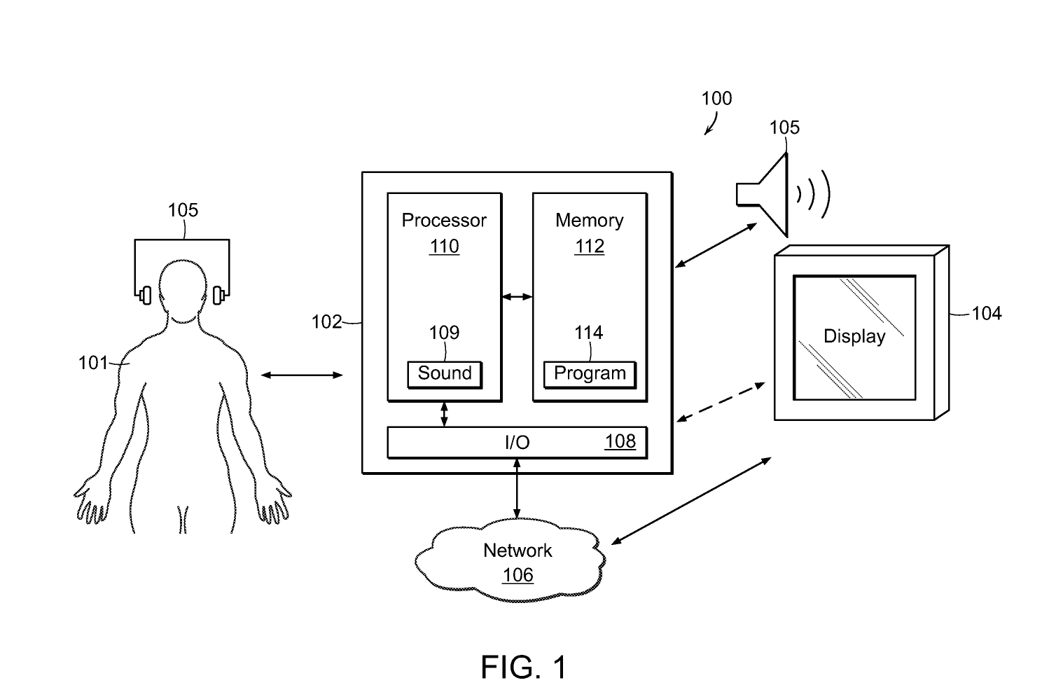

More specifically, as can be seen in FIG. 1, a system for selectively adjusting the volume of computer applications 100 according to embodiments of the instant invention includes a user computer 102 associated with a user 101, a communications network 106, a computer display 104, and speaker device 105. As one skilled in the art will appreciate, user computer 102 can be any type of computing device (e.g., a desktop computer, laptop computer, personal digital assistant (PDA), cellular telephone such as a Smartphone (Blackberry®, iPhone®, Android®-based phone), computer tablet, networked computer display, television as well as any other electronic device capable of connecting to the communications network 106, speaker devices 105 and display 104 to enable system interaction with user 101). Moreover, speaker devices 105 and display 104 may be integrated into user computer 102 in some embodiments (e.g., within the same case, and are therefore not necessarily housed in separate devices or components).

As previously mentioned, the user computer 102 is connected to the communications network 106 (e.g., to receive internet based video content or audio files). The communications network 106 may be a single communications network or comprised of several different communications networks. As such, communications network 106 can be a public or private network (e.g., which may be any combination of the internet and intranet systems that allow a user to interact with the computer program described herein). For example, communications network 106 can connect the user computer 102 to the internet and/or file server (not shown) using a local area network (“LAN”) (e.g., Ethernet or WI-FI), or wide area network (“WAN”) (e.g., LAN to LAN via internet tunneling, or a combination thereof), and using electrical cable (e.g., HomePNA or power line communication), optical fiber, and radio waves (e.g., wireless LAN, to transmit data). As one skilled in the art will appreciate, in some embodiments, the user computer 102 may be networked with the computer display 104 using a LAN for a university, home, apartment building, etc.(e.g., in embodiments where the user computer is a file server storing the application described herein). In other instances, the user computer 102 can include display 104 in the same housing (e.g., a laptop or iPad®. Still in other implementations, a user may connect to the user computer (e.g., via a separate device connected to a wireless LAN and the internet such as a system where the application described herein operates on a hosted website). Moreover, the term “communications network” is not limited to a single communications network system, but may also refer to separate, individual communications networks (e.g., those used to connect the user computer 102 to display 104 and the user computer 102 to the internet). Accordingly, though the user computer 102 is depicted as connected to a single communications network, such as the internet, an implementation of the communications network 106 using a combination of communications networks is within the scope of the invention.

As one skilled in the art will appreciate, the communications network may interface with the user computer 102 via a firewall (not shown) and web server (not shown) to provide a secure access point to the internet for the user 101. In some embodiments, the firewall may be a network layer firewall i.e., packet filters, application level firewalls, or proxy servers. In other words, in some embodiments, a packet filter firewall can be used to block traffic from particular source IP [global comment: introduce term before using acronym] addresses, source ports, destination IP addresses or ports, or destination service like www or FTP, though a packet filter in this instance would most likely block certain source IP addresses. In other embodiments, an application layer firewall may be used to intercept all packets traveling to or from the system, and may be used to prevent certain access to the network. Still, in other embodiments, a proxy server may act as a firewall by responding to some input packets and blocking other packets.

Returning to FIG. 1, a display 104 and speaker device 105 are connected to the user computer. As mentioned, the display 104 may be a display integrated in the same general housing with the user computer (e.g., a laptop or iPad® or similar device) or a wired or wireless monitor connected to the user computer 102 as an output device (e.g., a flat panel monitor connected to a desktop). As one skilled in the art will appreciate, in some embodiments, display 104 may be a monitor connected to the user computer 102 via a network, while in other embodiments the display 104 can be in close proximity to the user computer 102, e.g. a laptop, desktop, etc. Speaker device 105 can be any speaker device capable of receiving analog audio signals from (e.g., the user computer sound card 109). For example, in some embodiments, the speaker device 105 could be integrated into display 104 (e.g., a display device that includes speakers) in other embodiments, the speaker device 105 could be headphones, individual speakers, television speakers, etc. Accordingly, though speaker devices 105 are shown generically, one skilled in the art will appreciate that any speaker device capable of receiving an audio signal from the computer can be used in the inventive system.

Returning to FIG. 1, a user computer 102 can be any type of computer (e.g., a desktop, laptop, Smartphone, PDA, application server, or a plurality of computers) comprising a memory 112, a program product 114, a processor 110, a soundcard 109 and an input/output device (“I/O device”) 108. I/O device 108 connects the user computer 102 to a signal from the communications network 106 and to computer display 104, and can be any I/O device including, but not limited to a network card/controller connected by a PCI bus to the motherboard, etc.

As can be seen, the I/O device 108 is connected to the processor 110. Processor 110 is the “brains” of the user computer 102, and as such executes program product 114 and works in conjunction with the I/O device 108 to direct data to memory 112 and to send data from memory 112 to the various file servers and communications network. Processor 110 can be any commercially available processor, or plurality of processors, adapted for use in an user computer 102 (e.g., Intel® Xeon® multicore processors, Intel® micro-architecture Nehalem, AMD Opteron™ multicore processors, etc.) and may include a sound card as an integrated device thereon to receive digital files from memory and convert same to analog files for output by the speaker devices. Alternatively, sound card 109 can be an external card connected to the processor via and expansion slot and PCI bus as described above. Preferably, sound card 109 is capable of outputting several channels of audio signals by converting digital signals to polyphonic output. As one skilled in the art will appreciate, such a sound card may integrate its own drivers, or may use drivers associated with the processor to generate audio output.

Memory 112 may store the algorithms forming the computer instructions of the instant invention and data, and such memory 112 may consist of both non-volatile memory (e.g., hard disks, flash memory, optical disks, and the like) and volatile memory (e.g., SRAM, DRAM, SDRAM, etc.) as required by embodiments of the instant invention. As one skilled in the art will appreciate, though memory 112 is depicted on (e.g., the motherboard) of the user computer 102, memory 112 may also be a separate component or device (e.g., FLASH memory or other storage) connected to the user computer 102.

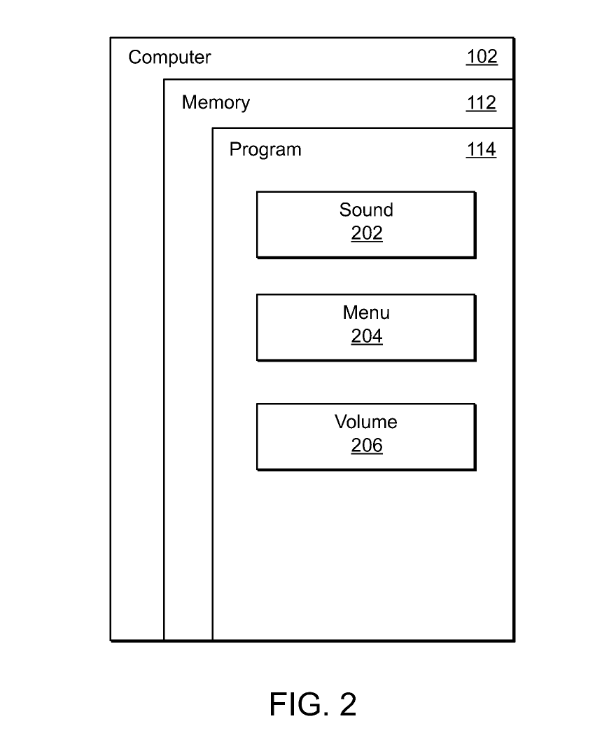

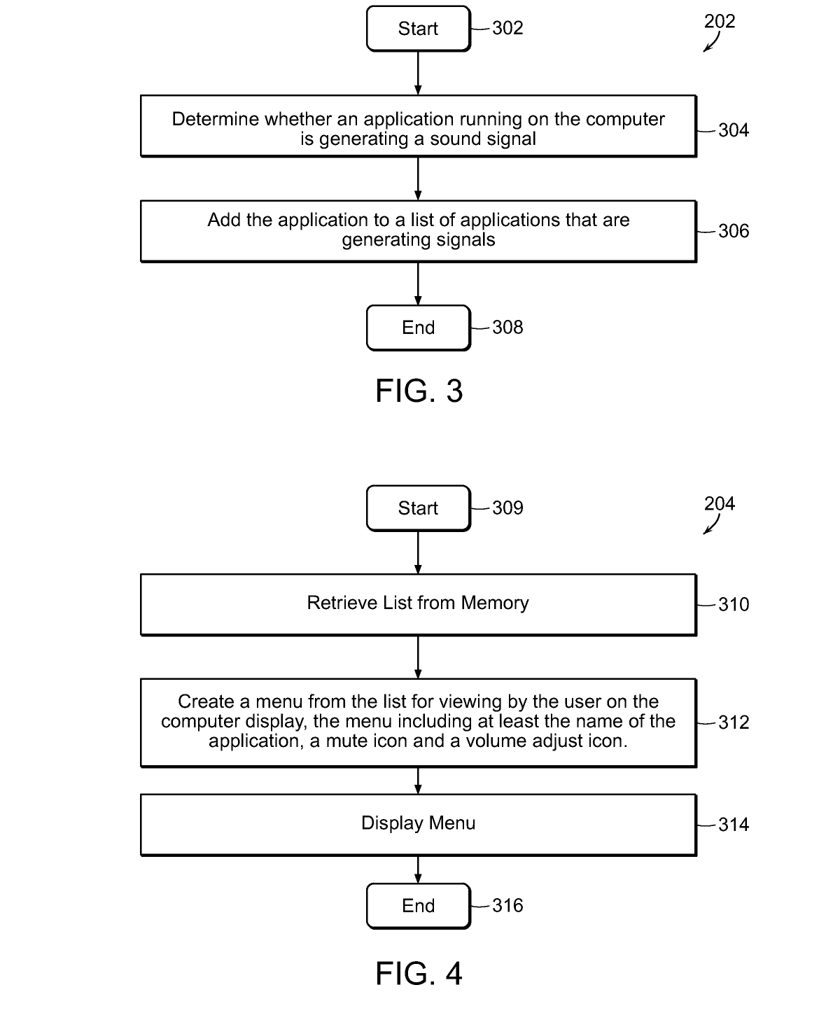

As shown in FIGS. 2 and 3, an embodiment for computer instructions implementing some of the functionality of the instant invention is stored in memory 112 as a plurality of programming modules. Such modules may include: a sound module 202 for determining which applications in the computer are generating signals for the sound car; a menu module 204 which lists the applications generating a sound for the user and formats a display for adjusting the sound; and a volume module 206, which receives input from the menu module 204 and uses the input to adjust the sound for the plurality of applications. As one skilled in the art will appreciate, the previous modules are exemplary only, and other modules and/or combination of modules may be implemented to achieve the functionality of the instant invention.

An exemplary embodiment of the computer program flow for processes implementing the sound module 202, the menu module 204, and the volume module 206 will now be discussed with reference to FIGS. 3-5. As one skilled in the art will appreciate, through the flow diagrams are shown as implemented in a serial configuration, such flow is for simplicity only and should be understood to include various loops and processes that may be run concurrently and/or used to implement each of the instructions, or a plurality of the instructions, therein.

Turning to FIG. 3, the sound module 202 is described and starts in step 302. In step 304, the instructions determine whether an application running on the computer is generating a sound signal. In some embodiments, the instructions may determine whether an application running on the computer is generating a sound signal at the instantiation of the application. For example, when a user connects to a YouTube® video, the program could determine whether the digital file uploaded to the system includes audio, or whether the video would like to have an output channel via the sound card. In other embodiments, the instructions may determine whether the application is generating a sound when the computer program of embodiments of the instant invention is initiated by the user (e.g., when the user selects the computer program from the display determining the applications utilizing the sound card and/or connected to computer output devices (such as an MP3 player connected to a USB)). For example, if the user is listening to music, playing a video game, and receives a Skype® call, the user may initiate the program, and the program may determine which applications are outputting a signal to the sound card or connected to a USB outlet of the computer. Still, in other embodiments, the instructions may include operations to periodically determine which applications are generating sound (e.g., every hour or the like). Moreover, as one skilled in the art will appreciate, though all embodiments describing times for determining whether an application is generating sound are not described herein, all are included within the scope of this disclosure.

In step 306, the program adds any application that is outputting an audio signal to a list of applications generating a sound. As one skilled in the art will recognize, in some embodiments, an application may be added to the list once it is determined the application is a new application generating a sound and concurrently remove all applications from the list that are no longer generating a sound, (e.g., at every instantiation of a new application or of the computer program). In other embodiments, the user may have the option to refresh a list of applications if the computer program has been previously initiated, and in some embodiments, the computer program may refresh a list of applications generating a sound at particular time intervals, such as every five minutes, to determine which applications are outputting signals to the sound card, etc.

Moreover, in some embodiments, the instructions could include determining the applications running on the computer that could generate an audio signal (e.g., Internet Explorer® or other web browsers, Skype®, Media Player, audio players, video players, hardware devices connected to the USB, IP communicator or other type of telephone system, games, etc.), and highlighting those currently running when the program product is initiated to generate the list. In some embodiments, the list may be ranked by determining which applications are higher priority than other applications, and automatically muting all applications of low priority. In other embodiments, the list may appear to the user before an application is muted. For example, if a user has Skype® as a priority application in the computer program, all application generating sound may automatically mute when a Skype® call is received, or alternatively, the user may see a “pop up” on their computer screen asking the user if they would like all applications muted. Accordingly, in such embodiments, the list function described above would also include a compare instruction to compare the list of applications generating a sound to a rank list of applications for sound priority. In other embodiments, the user may provide the ranking with a preferred speaker device. For example, the user may set audio for video games to be output from surround sound speakers connected to a television, iPod® music to be output from the iPod® speaker, YouTube videos to be output from a user port defining headphones, a Skype® call to be output using desktop or laptop speakers, etc. In such embodiments, the ranking system may selectively mute only applications that are competing for the same device, such as a Skype® call and a streaming video presentation requesting to use a channel dedicated to the computer monitor's audio. Moreover, in other embodiments, applications can be grouped together for selective mute. For example, if a user receives a Skype® call, and would like to mute all applications except Media Player so that the user and caller can review the same video, the user can group the remaining applications for selective muting, either automatically or manually. As one skilled in the art will appreciate, in any of these embodiments, the list and/or rank list is maintained in memory for retrieval and updates by the system. In step 308, the process ends.

Turning to FIG. 4, the instructions implementing the menu module 204 are described. As shown, the process starts in step 309, and in step 310, the menu module 204 retrieves the list generated by the sound module 202 and stored in memory. In step 312, the instructions create a menu from the list for viewing by the user on the computer display, the menu including at least the name of the application a mute icon and a volume adjust icon. As one skilled in the art will appreciate, though the mute icon and volume adjust icon are described herein as a picture, the mute icon and volume adjust icon can be any sort of display call or device that the user can select to mute an application or adjust the application's volume, and all such devices are included within the scope of this disclosure. As one skilled in the art will appreciate, if the list is generated upon instantiation of a computer application, the list may not be retrieved from memory, but generated in connection with step 312. Moreover, the menu may not be wholly created in step 312, but instead applications generating sound may be listed in a pre-programmed GUI for display to the user, with applications sending signals to the sound card highlighted or listed thereon. As one skilled in the art will appreciate, the menu associated with step 312 provides a single interface for all audio files output to the user computer's sound card, or connected to a computer's USB port (an iPod® or iPhone®. In step 314, the menu is displayed to the user. As one skilled in the art will appreciate, other computer program steps may be added to those described above to implement other features (e.g., so that the menu displayed can include special icons for the applications generating sound) including: a user select tab to select one or more applications or groups of applications to mute and control volume, a cancel application tab (e.g., to remove an application from the menu), an application sound rank (e.g., to set sound priorities for a plurality of user applications on the computer), an interrupt tab (e.g., to enable a program or disable programs to interrupt a computer session), and a selection tab to enable the user to set the application having the highest priority. Accordingly, though not all such instructions are described herein, all variations in implementation should be considered within the scope of the invention. In step 316, the process ends.

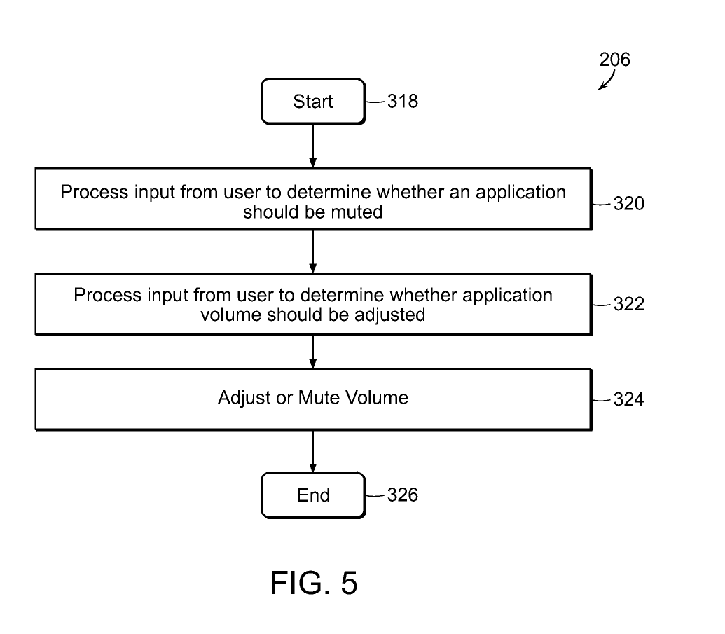

Turning to FIG. 5, the instructions implementing the volume module 206 is described, and the process starts in step 318. As described above, in some embodiments, each application transmitting an audio file to the sound card to be converted to an analog signal for output from the speaker devices, is included on the menu of applications that is either initiated by the user or initiated when a new audio file is sent to the sound card or an new hardware device is connected to the user computer USB. In such embodiments, the user selects a program or plurality of programs to mute in step 320. As one skilled in the art will appreciate, though not shown herein, the user may select a plurality of applications to mute at once in some embodiments. Alternatively, the user may select a mute tab next to the audio file to mute the file, or a volume tab next to the file to adjust the volume for the audio file. In step 322, the computer processes the user's selection (e.g., whether the user would like for a file to be muted or whether the user would like to adjust the volume for the application). For example, in some embodiments, the user may select to mute the volume for a plurality of applications, in other embodiments, the user may want to compare audio signals, and so adjusts the volume for the applications running the audio files the user wishes to compare and mute all other applications. In this way, the system, computer program product, and computer implemented method can enable a user to interact with one audio interface to adjust sound for a plurality of applications. Once the program determines the whether the user wishes to adjust the sound of the application, in step 324, the program adjust the sound. The process ends in step 326. In some embodiments, the application may adjust the sound by accessing the software generating the audio signal and interfacing with same at an application level (e.g., telling the application to mute or adjust the application's volume). In other embodiments, the program may include instructions to determine which output channel an audio file for an application is using, and mute or adjust the volume for the same(e.g., disconnect the application from the channel), and though not all such instructions are described herein, all variations in implementation should be considered within the scope of the invention.

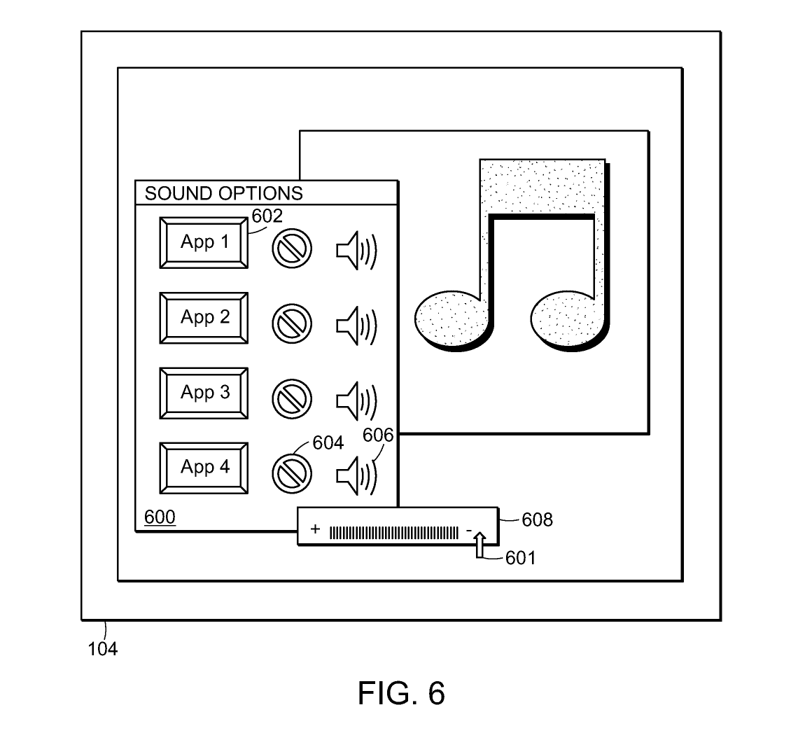

Turning to FIG. 6, a GUI implementing the menu having a plurality of applications listed thereon is described. As can be seen, the GUI includes a sound menu 600 listing a plurality of applications 602 that are outputting an audio file for the user computer sound card, or are hardware devices connected to the USB. Each application includes a mute tab 604 and a volume adjust tab 606. As one skilled in the art will appreciate, features such as a ranking tab, group select tabs, preferred speaker device tab etc., are not included in the exemplary GUI shown, but should be included within the scope of this disclosure. Returning to FIG. 6, when a user selects the volume adjust tab 606, a volume adjust display 608 is initiated on the user's computer. Such volume adjust display includes a volume bar that can adjust the volume of the particular application to be greater or less than a current level using cursor 601.

As one skilled in the art will further appreciate, the display page of FIG. 6 is an exemplary of the GUIs that may be initiated by the computer program of the instant invention to perform the inventive functions herein. Other GUIs may be created that will enable a user to select special icons for the applications generating sound, select a plurality of applications to mute and control volume, select to cancel an application from the menu (e.g., to remove an application from the menu), select a rank for an application (e.g., to set sound priorities for a plurality of applications on the computer), set an interrupt tab (e.g., to enable an application or disable an application interrupt for a computer session), and select the application having the highest priority. Accordingly, not all embodiments of such GUIs have been described herein, but will be apparent to one of skill in the art. Accordingly, various GUIs may be used instead of or in addition to the GUIs described herein, and the GUIs are in no way to be considered limiting to the specification and claims, but are used for a descriptive sense only.

Moreover, in the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification, and such modifications and changes are to be considered equivalents and part of this disclosure.

1. A computer allowing a user to selectively mute a computer application, the computer comprising:
a computer display, and
a tangible non-transitory computer memory, the computer memory having stored thereon a plurality of computer instructions performing a process of creating a menu of computer applications running on the computer and a process of allowing the user to select from the menu of applications a particular application to mute, the instructions including the steps of:
determining whether an application running on the computer is generating a sound signal;
responsive to determining whether the application is generating a sound signal, adding the application to a list of applications that are generating sound signals; and
creating a menu from the list for viewing by the user on the computer display, the menu including at least one of a name of the application and a mute icon.

2. The computer of claim 1, wherein the menu further includes a volume icon and wherein the instructions stored in the computer memory further execute the steps of:
enabling the user to select the volume icon for the particular application;
displaying a volume menu, responsive to the selection of the volume icon, the volume menu including a volume increase tab and a volume decrease tab;
increasing the volume of the particular application if the volume increase tab is selected by the user; and
decreasing the volume of the particular application if the volume decrease tab is selected by the user.

3. The computer of claim 1, wherein the menu further includes a priority icon and wherein the instructions stored in the computer memory further execute the steps of:
enabling the user to designate a priority for the particular application from the plurality of applications, the priority at least including the designation of high priority application,
wherein when the particular application is selected as the high priority application, the plurality of applications will automatically mute if the particular application is generating the sound signal.

4. The computer of claim 3, wherein the instructions further include the step of:
enabling the user to select a new application to add to the plurality of applications in the menu;
enabling the user to select a priority for each of the plurality of applications in the menu, the priority including at least successive numbers, the successive numbers determining the priority of each application with respect to each other application; and
automatically muting the particular application if it is lower priority than another application running on the user computer.

5. The computer of claim 1, wherein the instructions further include the step of:
updating the menu when a new application generating a sound signal is initiated; and
creating a pop-up menu when the menu is updated, the pop-up menu allowing the user to mute all of the plurality of applications in the list in favor of the new application.

6. The computer of claim 1, wherein the instructions further include the step of:
enabling the user to select icons for each of the plurality of applications in the menu;
initiating the selected icon for each of the plurality of applications at each successive initiation of the computer instructions; and
adding a plurality of hardware devices to the menu,
wherein the plurality of hardware devices can be selectively muted from the menu.

7. The computer of claim 1, wherein the instructions further include the step of:
comparing the list of applications generating a sound to a pre-designated list of application priority; and
prompting the user to mute applications in the list of applications according to application priority.

8. A computer program product comprised of a series of instructions executable on a computer, the computer program product performing a process of creating a menu of computer applications running on the computer and a process of allowing a user to select from the menu of applications a particular application to mute, the computer program product implementing the steps of:
determining whether an application running on the computer is generating a sound signal;
responsive to determining whether the application is generating a sound signal, adding the application to a list of applications that are generating sound signals; and
creating a menu from the list for viewing by the user on a computer display, the menu including at least one of a name of the application and a mute icon.

9. The computer program product of claim 8, wherein the menu further includes a volume icon and wherein the instructions further execute the steps of:
enabling the user to select the volume icon for the particular application;
displaying a volume menu, responsive to the selection of the volume icon, the volume menu including a volume increase tab and a volume decrease tab;
increasing the volume of the particular application if the volume increase tab is selected by the user; and
decreasing the volume of the particular application if the volume decrease tab is selected by the user.

10. The computer program product of claim 8, wherein the menu further includes a priority icon and wherein the instructions stored further execute the steps of:
enabling the user to designate a priority for the particular application from the plurality of applications, the priority at least including the designation of high priority application,
wherein when the particular application is selected as the high priority application, the plurality of applications will automatically mute if the particular application is generating a sound signal.

11. The computer program product of claim 10, further including instructions for:
enabling the user to select a new application to add to the plurality of applications in the menu;
enabling the user to select a priority for each of the plurality of applications in the menu, the priority including at least successive numbers, the successive numbers determining the priority of each application with respect to each other application;
automatically muting the particular application if it is lower priority than another application running on the user computer.

12. The computer program product of claim 8, further including instructions for:
updating the menu when a new application generating a sound signal is initiated; and
creating a pop-up menu when the menu is updated, the pop-up menu allowing the user to mute all of the plurality of applications in the list in favor of the new application.

13. The computer program product of claim 8, further including instructions for:
enabling the user to select icons for each of the plurality of applications in the menu;
initiating the selected icon for each of the plurality of applications at each successive initiation of the computer instructions; and
adding a plurality of hardware devices to the menu,
wherein the plurality of hardware devices can be selectively muted from the menu.

14. The computer program product of claim 8, further including instructions for:
comparing the list of applications generating a sound to a pre-designated list of application priority; and
prompting the user to mute applications in the list of applications according to application priority.

15. A computer-implemented method comprised of a series of instructions that cause a computer to perform a process of creating a menu of computer applications running on the computer and a process of allowing the user to select from the menu of applications a particular application to mute, the instructions including the steps of:
determining whether an application running on the computer is generating a sound signal;
responsive to determining whether the application is generating a sound signal, adding the application to a list of applications that are generating sound signals; and
creating a menu from the list for viewing by the user on a computer display, the menu including at least one of a name of the application and a mute icon.

16. The computer-implemented method of claim 15, wherein the menu further includes a volume icon and wherein the method further includes the steps of:
enabling the user to select the volume icon for the particular application;
displaying a volume menu, responsive to the selection of the volume icon, the volume menu including a volume increase tab and a volume decrease tab;
increasing the volume of the particular application if the volume increase tab is selected by the user; and
decreasing the volume of the particular application if the volume decrease tab is selected by the user.

17. The computer-implemented method of claim 15, wherein the menu further includes a priority icon and wherein the method further includes the steps of:
enabling the user to designate a priority for the particular application from the plurality of applications, the priority at least including the designation of high priority application,
wherein when the particular application is selected as the high priority application, the plurality of applications will automatically mute if the particular application is generating a sound signal.

18. The computer-implemented method of claim 17, further including the step of:
enabling the user to select a new application to add to the plurality of applications in the menu;
enabling the user to select a priority for each of the plurality of applications in the menu, the priority including at least successive numbers, the successive numbers determining the priority of each application with respect to each other application; and
automatically muting the particular application if it is lower priority than another application running on the user computer.

19. The computer-implemented method of claim 15, further including the step of:
updating the menu when a new application generating a sound signal is initiated; and
creating a pop-up menu when the menu is updated, the pop-up menu allowing the user to mute all of the plurality of applications in the list in favor of the new application.

20. The computer-implemented method of claim 15, further including the step of:
enabling the user to select icons for each of the plurality of applications in the menu;
initiating the selected icon for each of the plurality of applications at each successive initiation of the computer instructions; and
adding a plurality of hardware devices to the menu,
wherein the plurality of hardware devices can be selectively muted from the menu.
